(19) United States
(12) Patent Application Publication
(10) Pub. No.: US 2011/0187540 A1
(43) Pub. Date: Aug. 4, 2011

(54) WET ALERT! SYSTEMS

(76) Inventor: Curtis Schwab, Carbondale, CO (US)

(21) Appl. No.: 13/020,192

(22) Filed: Feb. 3, 2011

Related U.S. Application Data
(60) Provisional application No. 61/301,285, filed on Feb. 4, 2010.

(51) Int. Cl. G08B 21/18

(52) U.S. Cl. 340/605

(57) ABSTRACT

A drip tray alarm and container caddy system comprising a receptacle having an inner volume, a top side with a center and a perimeter lip, a bottom side and a plurality of side walls. The receptacle comprises an inner volume for containing leaked fluid. The top side of the drip tray alarm and container caddy system comprises a plurality of evenly-spaced downwardly-sloping drainage channels for receiving and directing at least one leaked fluid, a center-opening connecting the plurality of evenly-spaced downwardly-sloping drainage channels, and a detection and indicator device for detecting and indicating the presence of leaked fluid when the leaked fluid in the inner volume reaches a predetermined level. The top side further provides a storage surface for resting at least one container.

### CROSS-REFERENCE TO RELATED APPLICATION

The present application is related to and claims priority from prior provisional application Ser. No. 61/301,285, filed Feb. 4, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of leak detection and fluid collection devices and more specifically relates to a fluid collection and alarm system which may additionally serve as a storage surface.

2. Description of the Related Art

Most kitchen and/or bathroom sinks are installed into cabinets which conceal the pipes and plumbing fixtures underneath the sink. Typically, these cabinets also provide storage space for cleaning supplies or other items. The piping underneath sinks usually comprises a u-shaped form and includes piping joints. Unfortunately a frequent problem with piping and plumbing systems in households is the malfunction of pipes and piping joints. Pipes and piping joints often get damaged over time or piping joints are not tightened properly thereby creating leaks.

Many water leaks underneath sinks occur unnoticed due to the fact that the piping is situated inside the sink-cabinets. Many homeowners do no check the inside of their cabinets regularly so that water may leak onto the surfaces below the piping over a period of time. Additionally, cleaning supplies or other items which are placed inside the cabinet underneath the sink may obstruct the view preventing visualization of small leaks. Therefore, these leaks may go unnoticed even if a homeowner inspects the cabinet to check for signs of leakage.

Undetected leakage may cause water damage to the surfaces below the plumbing fixtures. Even a small leak which remains undetected over a length of time may result in serious damage to cabinets, floor, walls, etc. In some cases, leakage of water may cause considerable damage to building structures, requiring costly repairs.

Various attempts have been made to solve the above-mentioned problems such as those found in U.S. Pat. Nos. 4,369,532; 6,414,598; 3,069,671; 4,814,752; 2006/0202846; and U.S. Pat. No. 4,114,644. This prior art is representative of leak detection and fluid collection devices. None of the above inventions and patents, taken either singly or in combination, is seen to describe the invention as claimed.

Therefore a need exists for a leak detection and fluid collection device which not only collects water and prevents it from leaking onto surfaces underneath plumbing fixtures but additionally gives a warning signal as soon as a threshold water level is reached within the collection receptacle. Further, a need exists for a leak detection and fluid collection device that protects the surface on which it is placed from water damage and at the same time provides a support surface so that no storage space within cabinets is lost.

Ideally, a leak detection and fluid collection device should be manufactured at a modest expense, be easy to install, operate reliably and require little maintenance. Thus, a need exists for a reliable fluid collection and leak detection device to detect and collect liquid, to provide storage space, and to avoid the above-mentioned problems.

### BRIEF SUMMARY OF THE INVENTION

In view of the foregoing disadvantages inherent in the known leak detection and fluid collection devices art, the present invention provides a novel drip tray alarm and container caddy system. The general purpose of the present invention, which will be described subsequently in greater detail, is to provide a device that is used to detect fluid leakage, collect leaking fluids, and which may additionally serve as a storage surface.

The present drip tray alarm and container caddy system disclosed herein preferably comprises the following components: a receptacle comprising a top side with a plurality of evenly-spaced downwardly-sloping drainage channels with a center-opening, and a detection and indicator device.

The receptacle may comprise an inner volume holding at least one gallon of water, a top side with a center and a perimeter lip, a bottom side and a plurality of side walls. The inner volume may comprise a fillable space bordered by the bottom side, the plurality of side walls and the top side. The receptacle may be snappably couplable and un-couplable to the top side. The receptacle and the top side may comprise plastic and may be manufactured via injection molding. The top side may provide a storage surface for resting at least one container comprising a cleaning solution.

As previously mentioned, the receptacle may comprise a center-opening in the top side. Preferably sixteen evenly-spaced downwardly-sloping drainage channels may be incorporated into the top side for receiving and directing at least one leaked fluid. The sixteen evenly-spaced downwardly-sloping drainage channels may comprise triangular-shaped openings. The sixteen evenly-spaced downwardly-sloping drainage channels may further comprise a taper having a higher profile adjacent the perimeter lip of the top side and a lower profile adjacent the center-opening of the top side. The taper directs the flow of liquid towards the center-opening and may provide a means for stacking a plurality of the drip tray alarm and container caddy systems during storage and shipping periods. The center-opening may connect the plurality of evenly-spaced downwardly-sloping drainage channels.

The drip tray alarm and container caddy system further comprises a detection and indicator device for detecting and indicating the presence of at least one leaked fluid when the leaked fluid reaches a predetermined level. The detection and indicator device may be attached to the top side of the receptacle, may be battery operated, and may comprise an audible alarm warning system.

The drip tray alarm and container caddy system is suitably sized to fit within a cabinet under at least one plumbing fixture so that leaked fluid from the plumbing fixture may be received by the drip tray alarm and container caddy system.

A kit is embodied herein for Wet Alert! Systems comprising a receptacle with a top side comprising drainage channels and a center-opening, a detection and indicator device, and a set of user instructions.

In accordance with the embodiments of the present invention a preferred method of use is disclosed herein comprising: placing a drip tray alarm and container caddy system underneath a sink to collect and contain at least one leaked fluid; activating a detection and indicator device for detecting and indicating the presence of the leaked fluid; checking the fluid collection and detection device when the detection and indicator device generates an audible alarm signal; draining collected fluid from the drip tray alarm and container caddy system; and optionally using a top side of the drip tray alarm and container caddy system as a chemical container storage space.

The present invention holds significant improvements and serves as a drip tray alarm and container caddy system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Wet Alert! Systems, constructed and operative according to the teachings of the present invention.

FIG. 1 shows a perspective view illustrating a drip tray alarm and container caddy system in an in-use condition according to an embodiment of the present invention.

FIG. 2 is a perspective view illustrating the drip tray alarm and container caddy system according to an embodiment of the present invention of FIG. 1.

FIG. 3 is a perspective view illustrating a detection and indicator device which is attached to the drip tray alarm and container caddy system according to an embodiment of the present invention of FIGS. 1 and 2.

FIG. 4 is a perspective view illustrating the drip tray alarm and container caddy system within a cabinet under a plumbing fixture in an in-use condition according to an embodiment of the present invention of FIGS. 1-3.

FIG. 5 is a flowchart illustrating a method of use according to an embodiment of the present invention of FIGS. 1-4.

The various embodiments of the present invention will hereinafter be described in conjunction with the appended drawings, wherein like designations denote like elements.

### DETAILED DESCRIPTION

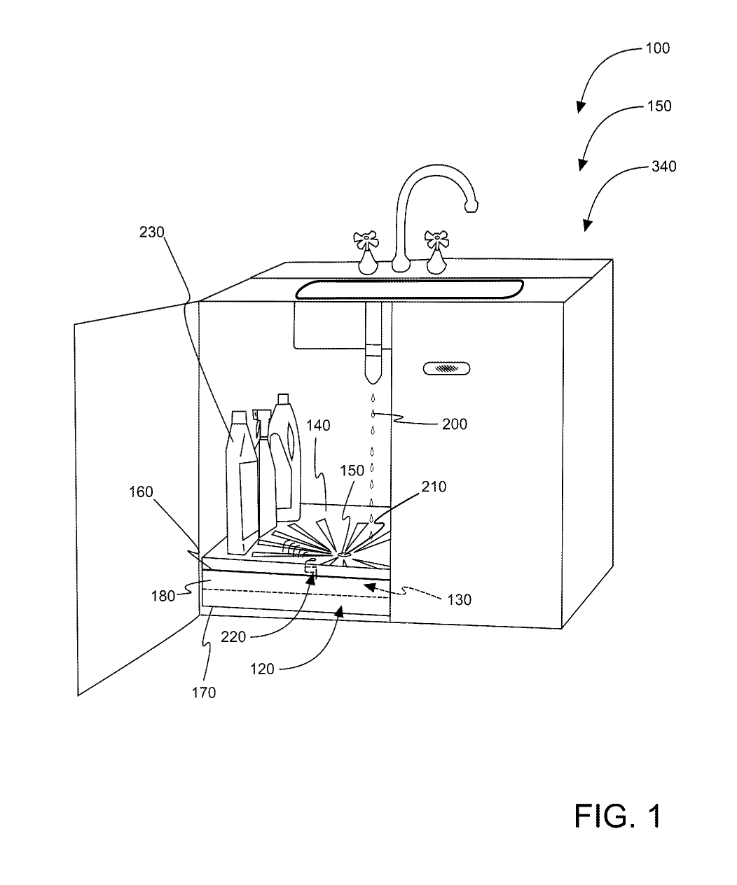

As discussed above, embodiments of the present invention relate to a leak detection and fluid collection device and more particularly to a fluid collection and alarm system which may additionally serve as a storage surface. Referring to the drawings by numerals of reference there is shown in FIG. 1, a perspective view illustrating a drip tray alarm and container caddy system 110 in an in-use condition 260 according to an embodiment of the present invention.

Drip tray alarm and container caddy system 110 of the present invention preferably comprises: receptacle 120 comprising inner volume 130, top side 140 with center 150, bottom side 170 and plurality of side walls 180. Inner volume 130 comprises a fillable space bordered by bottom side 170, plurality of side walls 180 and top side 140 for containing leaked fluid 200. Receptacle 120 therefore is usable for receiving and containing leaked fluid 200. Top side 140 comprises plurality of evenly-spaced downwardly-sloping drainage channels 190 incorporated into top side 140 for receiving and directing at least one leaked fluid 200. Top side 140 further comprises center-opening 210 in center 150 of top side 140 connecting plurality of evenly-spaced downwardly-sloping drainage channels 190. Top side 140 further is surrounded by perimeter lip 160. A detection and indicator device 220 for detecting and indicating the presence of leaked fluid 200 when leaked fluid 200 reaches a predetermined level in receptacle 120, is attached to top side 140. Top side 140 further provides a storage surface for resting at least one container 230.

User may place drip tray alarm and container caddy system 110 underneath a sink thereby creating in-use condition 260. If any water leakage occurs, the water will fall on the drip tray alarm and container caddy system 110, be collected by drainage channels 190 and directed through center-opening 210 into inner volume 130 of receptacle 120. Detection and indicator device 220 generates an audible alarm signal when leaked fluid 200 reaches a predetermined level inside inner volume 130 of receptacle 120. User then may drain collected fluid 200 from drip tray alarm and container caddy system 110.

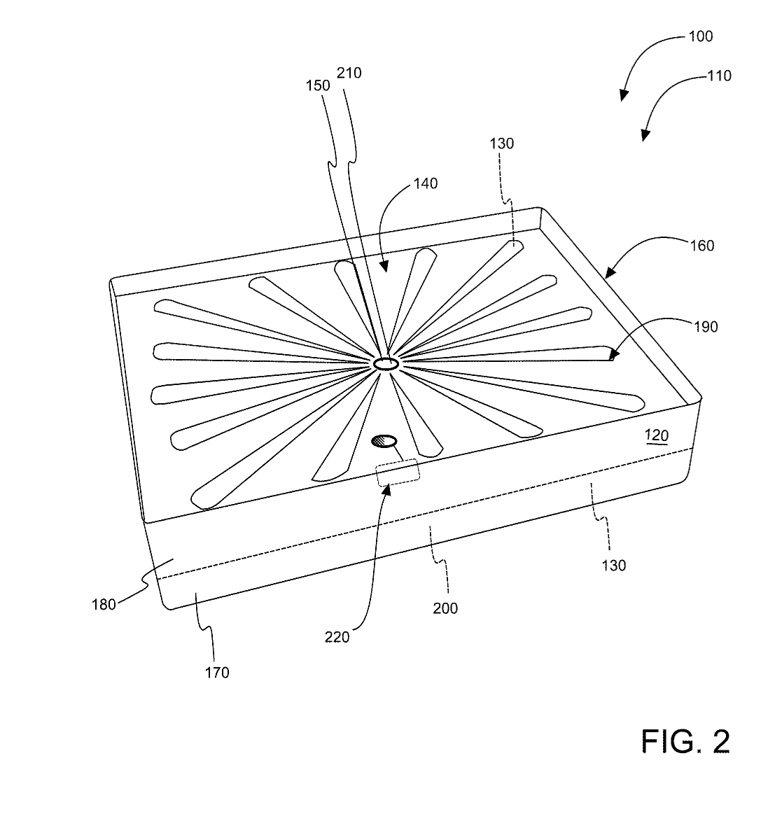

Referring now to FIG. 2, a perspective view illustrating drip tray alarm and container caddy system 110 according to an embodiment of the present invention of FIG. 1.

Drip tray alarm and container caddy system 110 comprises receptacle 120. Receptacle 120 comprises inner volume 130. Inner volume 130 may comprise a fillable space bordered by bottom side 170, plurality of side walls 180, and top side 140 and may preferably hold at least one gallon of water. Receptacle 120 further comprises top side 140 with center 150, bottom side 170 and plurality of side walls 180. Further, receptacle 120 may preferably measure approximately 22 inches in length, 14 inches in width, and 3½ inches in height including perimeter lip 160, which may measure 1 inch in height. Receptacle 120 may preferably be suitably sized to fit within a cabinet under at least one plumbing fixture.

Receptacle 120 may preferably comprise plastic and may preferably be manufactured via injection molding. However, receptacle 120 may comprise any other durable and suitable waterproof material, such as stainless steel or aluminum and may be manufactured via any suitable manufacturing process. Receptacle 120 may comprise plastic or rubber skirting on bottom side 170 and side walls 180 which may provide structural reinforcement, enhance the stability of receptacle 120 and add to the cosmetic appeal of drip tray alarm and container caddy system 110. Receptacle 120 may form a unit with top side 140. Alternatively, receptacle 120 may be snappable, couplable and un-couplable to top side 140 via clip fastener systems, such as, via a hinged lid system with clip fasteners which are fixed to receptacle 120 and which hook over onto top side 140 thereby attaching top side 140 to receptacle 120.

As previously mentioned, receptacle 120 may comprise top side 140. Top side 140 may comprise perimeter lip 160. Perimeter lip 160 may measure 1 inch in height and thereby prevent liquid from spilling over the edges of top side 140. Top side 140 may further comprise center-opening 210 in the center 150 of top side 140. Top side 140 may comprise preferably sixteen evenly-spaced downwardly-sloping drainage channels 190 incorporated into top side 140 for receiving and directing at least one leaked fluid 200.

The preferably sixteen evenly-spaced downwardly-sloping drainage channels 190 comprise a taper having a higher profile adjacent perimeter lip 160 and a lower profile adjacent center-opening 210. Each downwardly-sloping drainage channels 190 may have a width of 1 inch adjacent perimeter lip 160 and narrow to ¾ inch adjacent center-opening 210. The taper further provides a means for stacking a plurality of drip tray alarm and container caddy systems 110 during storage and shipping periods. The preferably sixteen evenly-spaced downwardly-sloping drainage channels 190 preferably are triangular-shaped in profile, downwardly-sloping from perimeter lip 160 towards center-opening 210, and are integrated into top side 140 via the appropriate manufacturing process depending on the material of top side 140, thereby providing structural strength.

Center-opening 210 connects the plurality of evenly-spaced downwardly-sloping drainage channels 190. If any water leakage occurs, the water will fall onto the top side 140 of drip tray alarm and container caddy system 110. The water will then be directed through downwardly-sloping drainage channels 190 and through center-opening 210 into receptacle 120 comprising inner volume 130. This way leaking fluids are being collected and damage to cabinets, floor, walls, etc. is being prevented.

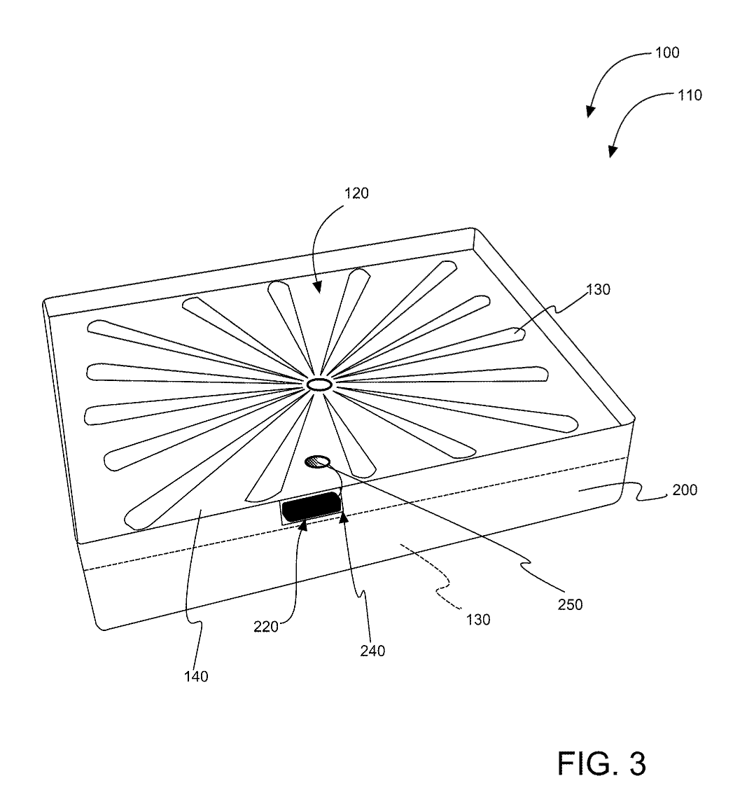

Referring now to FIG. 3, a perspective view illustrating a detection and indicator device 220 which is attached to the drip tray alarm and container caddy system 110 according to an embodiment of the present invention of FIGS. 1 and 2.

Drip tray alarm and container caddy system 110 preferably comprises detection and indicator device 220 for detecting and indicating the presence of leaked fluid 200 when leaked fluid 200 reaches a predetermined level in receptacle 120 comprising inner volume 130. Detection and indicator device 220 may preferably be attached to top side 140 of receptacle 120. Detection and indicator device 220 may be battery operated and comprise an audible alarm warning system.

Top side 140 of receptacle 120 may comprise snap system 240 molded into the design to facilitate attachment of detection and indicator device 220 to top side 140 of drip tray alarm and container caddy system 110. The wires of detection and indicator device 220 may pass through hole 250 on top side 140 into receptacle 120 descending to a predetermined level at which when contacted by water, the alarm is triggered. Alternatively, the wires may lead to the bottom of drainage channels 190 and into receptacle 120 in a manner where the components are not negatively impacted by leaked fluid 200. For use, the user installs a 9-V battery into the battery housing of detection and indicator device 220 and attaches detection and indicator device 220 to top side 140 of drip tray alarm and container caddy system 110 situated under the plumbing underneath the sink. When leaked fluid 200 reaches a predetermined level in receptacle 120 comprising inner volume 130, detection and indicator device 220 senses the presence of fluid and generates an audible alarm signal, thereby informing user about the leakage.

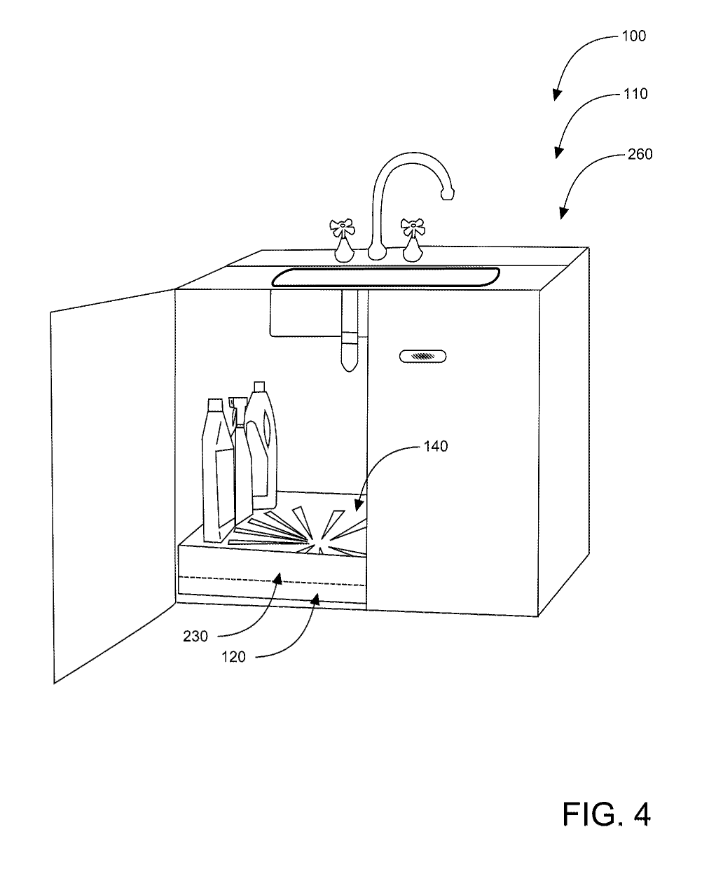

Referring now to FIG. 4, a perspective view illustrating the drip tray alarm and container caddy system 110 within a cabinet under a plumbing fixture in in-use condition 260 according to an embodiment of the present invention of FIGS. 1-3.

Top side 140 of receptacle 120 provides a storage surface for resting preferably at least one container 230 comprising a cleaning solution. Top side 140 of receptacle 120 provides a flat sturdy surface which may be used to store cleaning supplies or other items. Drip tray alarm and container caddy system 110 therefore provides a solution for preventing water damage without users having to sacrifice storage space. Drip tray alarm and container caddy system 110 protects the surface on which it is placed from water damage and at the same time provides a support surface so that no storage space within cabinets is lost.

Wet Alert! Systems 100 may be sold as kit 400 comprising the following parts: at least one receptacle 120 with top side 140 comprising drainage channels 190 and center-opening 210, at least one detection and indicator device 220, and at least one set of user instructions. Wet Alert! Systems 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

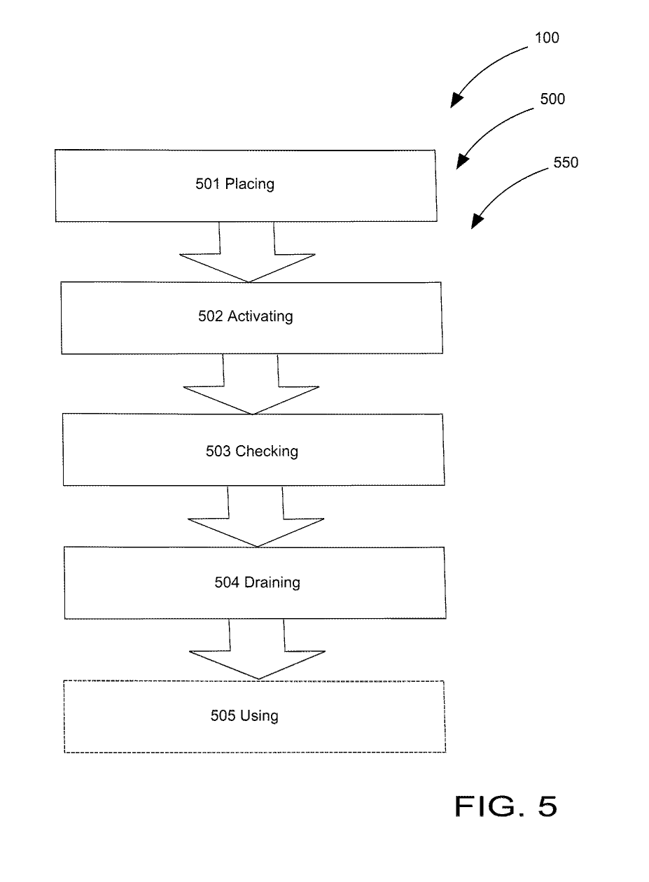

Referring now to FIG. 5, a flowchart 550 illustrating a method of use 500 according to an embodiment of the present invention of FIGS. 1-4.

In accordance with the embodiments of the present invention a preferred method of use 500 is disclosed herein comprising: step one 501 placing drip tray alarm and container caddy system 110 underneath a sink to collect and contain at least one leaked fluid 200; step two 502 activating a detection and indicator device 220 for detecting and indicating the presence of leaked fluid 200; step three 503 checking the fluid collection and detection device when the detection and indicator device 220 generates an audible alarm signal; step four 504 draining collected leaked fluid 200 from drip tray alarm and container caddy system 110; step five 505 using a top side 140 of the drip tray alarm and container caddy system 110 as a chemical container 230 storage space.

It should be noted that step five 505 is an optional step and may not be implemented in all cases. Optional steps of method of use 500 are illustrated using dotted lines in FIG. 5 so as to distinguish them from the other steps of method of use 500.

It should be noted that the steps described in the method of use 500 can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A drip tray alarm and container caddy system comprising:
a receptacle having an inner volume, a top side with a center and a perimeter lip, a bottom side and a plurality of side walls;
a plurality of evenly-spaced downwardly-sloping drainage channels incorporated into said top side for receiving and directing at least one leaked fluid;
a center-opening in said top side connecting said plurality of evenly-spaced downwardly-sloping drainage channels; and
a detection and indicator device for detecting and indicating the presence of said at least one leaked fluid when said leaked fluid reaches a predetermined level;
wherein said receptacle comprises said inner volume for containing said at least one leaked fluid, said inner volume comprising a fillable space bordered by said bottom side, said plurality of side walls and said top side, said top side which is surrounded by said perimeter lip;
wherein said detection and indicator device is attached to said top side of said receptacle; and
wherein said top side provides a storage surface for resting at least one container and said receptacle is usable for receiving and containing said at least one leaked fluid.

2. The drip tray alarm and container caddy system of claim 1 wherein said receptacle is snappably couplable and un-couplable to said top side.

3. The drip tray alarm and container caddy system of claim 2 wherein said receptacle and said top side comprise plastic and are manufactured via injection molding.

4. The drip tray alarm and container caddy system of claim 1 wherein said perimeter lip comprises plastic skirting providing structural reinforcement.

5. The drip tray alarm and container caddy system of claim 1 wherein said evenly-spaced downwardly-sloping drainage channels comprise a taper having a higher profile adjacent said perimeter lip and a lower profile adjacent said center-opening.

6. The drip tray alarm and container caddy system of claim 1 wherein said detection and indicator device is situated inside said receptacle.

7. The drip tray alarm and container caddy system of claim 1 wherein said detection and indicator device is battery operated.

8. The drip tray alarm and container caddy system of claim 1 wherein said detection and indicator device comprises an audible alarm warning system.

9. The drip tray alarm and container caddy system of claim 1 wherein said top side comprises sixteen of said evenly-spaced downwardly-sloping drainage channels.

10. The drip tray alarm and container caddy system of claim 1 wherein said evenly-spaced downwardly-sloping drainage channels comprise triangular-shaped openings.

11. The drip tray alarm and container caddy system of claim 1 wherein said evenly-spaced downwardly-sloping drainage channels provide structural strength.

12. The drip tray alarm and container caddy system of claim 1 wherein said container comprises a cleaning solution.

13. The drip tray alarm and container caddy system of claim 1 wherein said drip tray alarm and container caddy system is suitably sized to fit within a cabinet under at least one plumbing fixture.

14. The drip tray alarm and container caddy system of claim 13 wherein said leaked fluid is received from said plumbing fixture.

15. The drip tray alarm and container caddy system of claim 5 wherein said taper provides a means for stacking a plurality of said drip tray alarm and container caddy systems during storage and shipping periods.

16. The drip tray alarm and container caddy system of claim 1 wherein said inner volume holds at least one gallon of water.

17. A drip tray alarm and container caddy system comprising:
a receptacle
having an inner volume holding at least one gallon of water, a top side with a center and a perimeter lip comprising plastic skirting and providing structural reinforcement, a bottom side and a plurality of side walls, said inner volume comprising a fillable space bordered by said bottom side, said plurality of side walls and said top side,
wherein said receptacle is snappable, couplable and un-couplable to said top side,
wherein said receptacle and said top side comprise plastic and are manufactured via injection molding, and
wherein said top side provides a storage surface for resting at least one container comprising a cleaning solution;
a center-opening in said top side;
sixteen evenly-spaced downwardly-sloping drainage channels incorporated into said top side for receiving and directing at least one leaked fluid,
wherein said sixteen evenly-spaced downwardly-sloping drainage channels comprise a taper having a higher profile adjacent said perimeter lip and a lower profile adjacent said center-opening, said taper providing a means for stacking a plurality of said drip tray alarm and container caddy systems during storage and shipping periods,
wherein said center-opening connects said plurality of evenly-spaced downwardly-sloping drainage channels,
wherein said sixteen evenly-spaced downwardly-sloping drainage channels comprise triangular-shaped openings, and provide structural strength; and
a detection and indicator device for detecting and indicating the presence of said at least one leaked fluid when said leaked fluid reaches a predetermined level,
wherein said detection and indicator device is attached to said top side of said receptacle, battery operated and comprises an audible alarm warning system;
wherein said drip tray alarm and container caddy system is suitably sized to fit within a cabinet under at least one plumbing fixture and said leaked fluid is received from said plumbing fixture.

18. The drip tray alarm and container caddy system of claim 17 comprising a kit further including said receptacle with a top side comprising drainage channels and a center-opening, a detection and indicator device, and a set of user instructions.

19. A method of using a drip tray alarm and container caddy system comprising the steps of:
placing a drip tray alarm and container caddy system underneath a sink to collect and contain at least one leaked fluid;
activating a detection and indicator device for detecting and indicating the presence of said leaked fluid;
checking said fluid collection and detection device when said detection and indicator device generates an audible alarm signal; and
draining collected fluid from said drip tray alarm and container caddy system.

20. The method of using a drip tray alarm and container caddy system of claim 19 further comprising the step of using a top side of said drip tray alarm and container caddy system as a chemical container storage space.
